(19) United States
(12) Patent Application Publication
(10) Pub. No.: US 2012/0259659 A1
(43) Pub. Date: Oct. 11, 2012

(54) MEDICAL FACILITY MANAGEMENT SYSTEM

(75) Inventors: Joshua Robert Fotheringham, Highlands Ranch, CO (US); James Hoyt Jarman, Brea, CA (US); David Smith Howell, Brea, CA (US)

(73) Assignee: JDJ Enterprises, Highlands Ranch, CO (US)

(21) Appl. No.: 13/248,535

(22) Filed: Sep. 29, 2011

Related U.S. Application Data
(60) Provisional application No. 61/387,917, filed on Sep. 29, 2010.

(51) Int. Cl. G06Q 50/24

(52) U.S. Cl. 705/3

(57) ABSTRACT

Embodiments of the invention relate to methods and systems for communicating patient information to a third party through various communication interfaces. Patient information can include activities of daily living, billing codes, etc.

### CROSS-REFERENCES TO RELATED APPLICATIONS

This is a non-provisional application that claims the benefit of commonly assigned U.S. Provisional Application No. 61/387,917, filed Sep. 29, 2010, entitled “Medical Facility Management System,” the entirety of which is herein incorporated by reference for all purposes.

### BACKGROUND

Patient care is a booming industry. In the modern world patients often expect that the collection, processing, correlation, reporting, and/or management of patient care data occurs quickly.

### SUMMARY

Embodiments of the invention relate to methods and systems for communicating patient information to a third party through various communication interfaces. Patient information can include activities of daily living, billing codes, etc.

### BRIEF DESCRIPTION OF THE FIGURES

FIG. 1 shows a high-level view of a PatientView system according to some embodiments of the invention.

FIG. 2 is a chart showing the various components that can be used to important patient specific data into the PatientView database.

FIGS. 3 and 4 both show reporting rules for support provided codes.

FIG. 5 shows a simplified block diagram of a computer system 500 that can be used in the various embodiments of the invention.

FIG. 6A shows a sample ADL report with a patient's bed mobility scores.

FIG. 6B is a sample chart of various ADL codes.

FIG. 7 is a flow chart showing a standard iPhone application user interface and coding according to some embodiments of the invention.

### DETAILED DESCRIPTION

According to some embodiments of the invention, an application is provided for use with mobile computing device that includes, multiple web portals, and a set of communication tools that can support the Skilled Nursing Facility (SNF) industry. This application is referred to herein as PatientView. This application can be separated into multiple phases to support and validate core revenue-based assumptions.

According to some embodiments, a mobile computing device application can enable Certified Nursing Assistants (CNAs) the ability to capture data associated with the services they provide to each of their patients. For example, these services can be called Activities of Daily Living (ADLs). ADLs are the principle driver behind Medicare reimbursements provided to the SNF by the US Federal government. In some embodiments, these ADLs can be captured as they are performed (real-time) via an interface within an mobile computing device application.

Mobile computing devices can include various portable computing devices such as iPhones, iPads, tablets, netbooks, smart phones, PDAs, etc.

The assumption is that by forcing CNAs to capture ADLs at point of service, they can be more accurate and better represent the services being provided. Additionally, by using a very specific pattern of questions, CNAs are assumed to be influenced to provide the most accurate reimbursement coding possible. As a result, Medicare reimbursements will increase and SNF revenues will grow. In some embodiments, the application can not only enable point of service data entry, but also drive accurate data capture through prompts, reminders, etc.

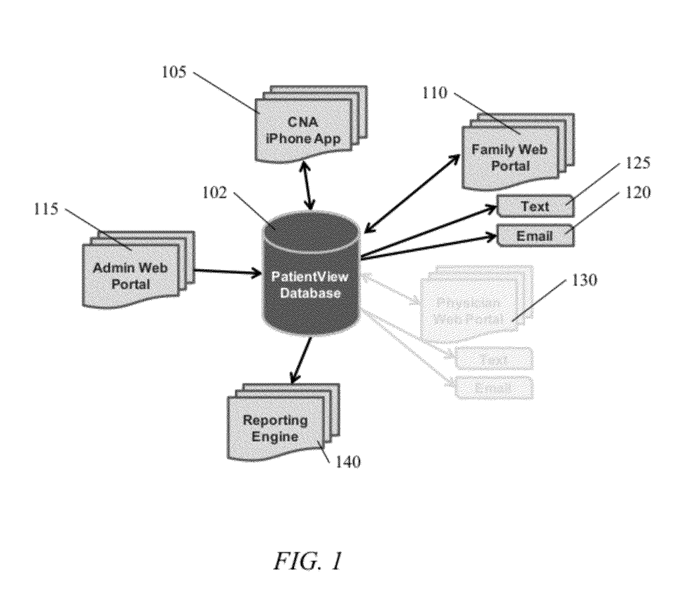

FIG. 1 shows a high-level view of a PatientView system according to some embodiments of the invention. A database 102 can collect information about a patient from various sources including the CNA application 105 on a mobile device. Various portals can allow families 110, physicians 130, or administrators 115 to view information in the database. Moreover, the database can be used to automatically send emails 120 and/or text messages 125 to family members, doctors, administrators, etc. when an event trigger has occurred. Report engine can be used to generate various reports from the data in database 102.

In some embodiments, Family Web Portal 110 can provide facilities with the ability to virtually link nurses and caregivers with the intent of providing both transparency in SNF care as well as bi-directional interaction. Family members can have access to ADLs translated into meaningful text and request specific updates from their patient's CNAs. Additionally, family members can determine their notification type (email or text) if they desire to receive updates other than those available within Family Web Portal 110. In some embodiments, family members can also choose an interval for messaging (real-time or weekly).

In some embodiments, the Administrative Portal 115 can allow facilities and administrators the ability to manage users, facility settings, nurses, and communications. This portal can also enable report generation for both Medicare reimbursement and CNA Utility.

In addition to the application, the Family Web Portal 110, and the Administrative Portal 115, a basic Patient database 101 and a reporting engine 140 that can drive the above mentioned reports.

Some embodiments of the invention provide a decision tree for use by staff (e.g., a nurse, CAN, etc.) at a SNF (or other medical center) that determines the best ADL score for a particular health care scenario. In some embodiments, the decision tree can query the staff regarding the performance of particular tasks related to ADLs. These queries can vary from questions regarding the administration of medication, to physical labor performed by the staff, to queries regarding weight bearing tasks. From the response to the queries and/or the ADLs Medicare reimbursement can be determined. Various systems can be used to provide the decision tree and make the appropriate determinations. Various user interfaces can be used using mobile devices and/or desktop devices. Mobile devices can be used that can communicate information to a server using wireless communication techniques.

In some embodiments, the results of the queries and/or the ADL can be translated into terms that describe a patient's health or current abilities. These terms can be provided to family members or doctors of patients through multiple forms of communication (e.g., web portal, text, email, etc.). Family members and/or doctors can also query the staff through any of the multiple forms of communication regarding the status and/or health of a patient.

iPhone Application

While the following embodiments are described using an iPhone application, these embodiments are not limited to an iPhone. Any type of mobile computing device can be used.

According to some embodiments, an iPhone application can replace an existing product from another company that currently resides in more than 4,000 SNFs: Care Tracker. This software tool can be integrated into mounted touch-screen monitors throughout SNFs. ADLs tracking within the iPhone application can be very similar to how they are tracked with Care Tracker. However, point of service capture and technology-driven behavior improvements drive the added value of the PatientView solution.

An example of an initial PatientView solution can include a CAN iPhone application, the Family web Portal, the Administrative Portal, and a Reporting Engine. In the near future, the Physician web Portal can be developed and included within the full solution.

A CNA iPhone Application can allow CNAs to capture point of service data tied to the ADL activities performed for each patient. Example ADLs include toileting, mobility, medications, activities, eating habits, sleeping habits, treatments, and transfers. The application can require authentication and/or can filter those patients for which a CNA is responsible. It can also prompt CNAs to accurately capture all services provided. All data collected via this application can be wirelessly transmitted to the Basic PatientView Database.

An Administration Web Portal is a SNF-specific website that can handle administrative data input, correlation, feature selection, and report access. As an example, this web portal can be the data entry point for patient names, CNA names, patient assignments to CNAs, facility settings, and reimbursement report generation.

A Family Web Portal 110 can be an access point for authorized family members to access update and status information associated to their patient. Family members cab be able to send notification requests directly CNAs as well as determine additional communications vehicles (text and/or email) whereby patient information can be sent.

Data entered via the Administrative Web Portal, the Family Web Portal 110 and the CNA iPhone application can be captured and stored within the Basic PatientView Database. Administrative data stored within the database can be pushed to the iPhone application to both enable application functionality and data viewing. CNA iPhone application data stored within the database can be compiled and exported by the Reporting Engine.

The Reporting Engine can be used to leverage data stored within the Basic PatientView Database and calculates reimbursement scores based on embedded logic. These scores can be exported to a report that can be used by MDS Coordinators to eventually submit for Medicare reimbursement. A Utility Report detailing the activities performed by CNAs or the activities performed on behalf of patients is also generated via the Reporting Engine.

Various user classes and characteristics can be used. For example, A CNA user class can only have access to the iPhone application. CNAs can be required to authenticate and log into the application. This login can limit CNAs to viewing only those patients within their associated SNF. As depicted on the Administration Web Portal, CNAs can be able see a filtered list of their assigned patients and be able to enter ADL data for each of their patients. CNAs can also be able to enter data for all patients within the SNF, although if the patient is not assigned to the CNA, they can not appear in the filtered list.

A Family Member class can be enabled by their Family Administrator, Family Members can send a notification request to all CNAs assigned to their patient. They are able to determine whether they would like to also receive updates via text or email and the frequency of the updates (real-time or weekly). Family Members can also update their own personal settings within the Family Web Portal.

A user associated with the Family Administrator class can be enabled to add/remove family members as well as remove notification requests.

A Basic Administrator can have the least amount of functionality. This administrator can add and deactivate patients as well as assign Family Administrators.

In some embodiments, in addition to all Basic Administrator functionality, a MDS Coordinator can run both reports available within this phase of development (MDS 3.0 Report and CNA Utility Report).

A Nursing Administrator (often referred to as the Dir of Nursing or DON) can have all available functionality assigned to the MDS Coordinator and the Basic Administrator. This administrator can add and remove CNA information, assign CNAs to patients, assign patients to CNAs, set family request limits, allow courtesy updates, review pending notifications, create canned responses, review custom responses, review courtesy responses, and receive nursing (or DON) notifications.

A Facility Administrator can access to all available functionality of the above administrators. This administrator can also be able to manage all administrative accounts within the associated facility. In addition, this administrator is enabled to send executive messages to all CNAs, family members, or both.

A Super Administrator can have access to all administrative functionalities across all facilities. Additionally, the Super Administrator sets up new facilities and Facility Administrators.

The iPhone application is expected to be developed using Apple's iOS4 Operation System/SDK and can be functional using either an iPhone 3G (or later) or an iPod Touch (2G or later). Data transmission via WiFi can be enabled and co-exist with 3G (or later) cellular data transmission.

This disclosure includes appendices with various examples of embodiments described herein. These appendices do not limit the scope of this disclosure.

In some embodiments, if a user has a temporary lack of internet connectivity (whether via wifi or 3G), the application will temporarily display core information and capture and store inputted data until a live internet connection is reestablished. This will be only be required when new data is being added to the database. When data stored within the database will be updated via the iPhone application (e.g., replacing a patient's photo), a live connection will be required. This will prevent the application from having to manage overwrites.

In some embodiments, the Administration Web Portal (e.g., 115) can be a SNF-specific website that can handle all administrative data input, correlation, feature selection, and/or report access. This web portal may be designed either by administrative functionality or by administrator authorization type. The portal can be protected by a username and password. Each Administrative Portal can have the ability to be branded as that of the SNF to which it is tied. The name and logo of the SNF may be loaded onto the header of the associated Administrative Portal via a self-service tool or through standard HTML or other web language development.

In some embodiments, the Administration Web Portal can have a login screen. This section can be used, for example, to enable the administrator to authenticate him/herself through the entry of a username and password. The login screen may also allow, for example, a user to: 1) Select all available facilities within a drop-down selection box; 2) Reset passwords for users; and/or 3) Provide user instruction, legal requirements, terms, and/or conditions of user.

In some embodiments, the Administration Web Portal can have a Manage Patients section. This section can be used, for example, to enable the entry and management of patient data into a web-based tool to be used by the iPhone application, Family Web Portal, Administrative Portal, and Reporting Engine and to be stored in the Basic PatientView Database. All Patient Data Entries can be time stamped. The Manage Patients section may also allow a user to: 1) Add a patient, inclusive of First Name, Last Name, and Admission Date (all required fields). A Patient ID can be automatically assigned and should be unique across all patients, family members, and administrators within a particular facility. 2) View (and sort by column) all Patients (both active and inactive). 3) Activate and/or deactivate patients. 4) Delete patients. 5) Edit First Name, Last Name, and Admission Date. And/or 6) import a Microsoft Excel file containing Patient First Name, Last Name, and Admission Date.

in some embodiments, the Administration Web Portal can have a Manage Families section. This section can be used, for example, to enable the entry and management of family administrator data into a web-based tool to be used by the iPhone application, Family Web Portal, Administrative Web Portal, and Reporting Engine and to be stored in the Basic PatientView Database. This section can be used, for example, to: 1) Add a family administrator, inclusive of the following required fields: First Name, Last Name, Username, Password, and Email address. A Family Administrator ID can be automatically assigned and should be unique across all patients, family members, and administrators within a particular facility. The notification types are optional inclusive of: Real Time Text Messaging for non-automated updates, cell phone number (required if Real Time Text Messaging is selected), Real Time Email, and Weekly Email Summary. 2) Assign a Family Administrator to one or more patients. And/or 3) delete a Family Administrator. 4) Edit Family Administrator.

In some embodiments, the Administration Web Portal can have a Manage Reports section. This tool, for example, can be used to manage all reporting functionality. This section can allow a user to, for example, 1) Select date range (beginning and end dates) for the MDS 3.0 Reimbursement Report. 2) Run Report for selected patients or all patients. 3) Launch MDS 3.0 Reimbursement Report. 4) View (and sort by column) and Archive or Delete a Report. 5) Select date range (beginning and end dates) and Reporting Parameters (By Patient or By CNA) for the CNA Utility Report. 6) Run Report for selected CNAs or all CNAs. 7) Launch CNA Utility Report. And/or 8) view (sort by column) and Archive or Delete a Report

In some embodiments, the Administration Web Portal, for example, can have a Manage Nurses section. This section, for example, can be used for the entry and management of CNA data into a web-based tool to be used by the iPhone application, Family Web Portal, Administrative Web Portal and/or Reporting Engine and to be stored in the Basic PatientView Database. All CNA Data Entries can be time stamped. This section can include, for example: 1) Add a CNA, inclusive of the following required fields: First Name, Last Name, Username, Password, and Email address. A CNA ID can be automatically assigned and should be unique across all patients, family members, and administrators within a particular facility. 2) Assign CNAs to Patients and Patients to CNAs (many to many relationship). 3) View (and sort by column) all CNAs (both active and inactive). 4) Activate and/or deactivate CNAs. 5) Delete CNAs. 6) Edit CNA personal data. And/or 7) import a Microsoft Excel file containing CNA First Name, Last Name, Username, Password and Email address.

In some embodiments, the Administration Web Portal can have, for example, a Manage Facility section. This section, for example, can be used to enable the entry and management of unique facility data into a web-based tool to be used by the iPhone application, Family Web Portal, Administrative Web Portal and/or Reporting Engine and to be stored in the Basic PatientView Database. This section, for example, can include functions to allow a user to 1) Add a Facility Admin, inclusive of the following required fields: First Name, Last Name, Username, Password, Email address and Administrative Role (see all Administrator options in Appendix C Model #2). A Facility Admin ID can be automatically assigned and should be unique across all patients, family members, and administrators within a particular facility. 2) Edit Facility Admin personal data. 3) View (and sort by column) all Facility Admin. 4) Delete a Facility Admin (note: at least one Facility Admin can exist at all times.) 5) Enable/Disable CNAs from sending Courtesy Updates to family members. 6) Set a limit to the number of Courtesy Updates a patient's total family can submit in one calendar week. And/or 7) send an Executive Message to any or all of the following: families of active patients, families of inactive patients, all CNAs, all administrators.

In some embodiments, the Administration Web Portal can have a Manage Communications section. This section can, for example, enable nursing supervisors (typically referred to as Directors of Nursing or DONs) to monitor and support all communications between the facility and the families of the patients. This section will utilize data from all aspects of the solution and all actions can be time stamped. In some embodiments, some or all of this functionality can also be replicated within an application for a mobile device. This section can allow a user to, for example, 1) view (and sort by column) all pending (or unanswered) notifications from family members. 2) Respond to any pending notification from family members. 3) View and Approve, Deny or Edit Courtesy Responses submitted by CNAs to family members. 4)View (with sort by column) and Approve, Deny or Edit Custom Responses submitted by CNAs in response to notifications sent by family members. 5) View (with sort by column) and Archive or Delete Notifications from CNAs to the DON. 6) View (with sort by column) archived Notifications from CNAs to the DON. 7) View and Add, Archive or Delete Standard Responses to be used by CNAs in response to notifications sent by family members. Tags can be enabled to easily allow users to personalize responses (example: <insert first name of patient> has taken all medication today.) 8) View (and sort by column) archived Standard Responses to be used by CNAs in response to notifications sent by family members. 9) Anytime a Pending Family Request, pending Courtesy Response, pending Custom Response, or pending Notification from CNA exists, the DON can be notified via a visual alert or other indication within the Administrative Web Portal.

In some embodiments, the Administration Web Portal can have a Super Admin Settings. These settings can, for example, enable the management of all administration across all facilities. This section can allow a user to, for example, 1) Add a Facility, inclusive of the following required fields: Facility Name, Facility Address, Facility Admin: First Name, Last Name, Username, Password, and Email address. A Facility ID can be automatically assigned and should be unique across all facilities. A Facility Admin ID can be automatically assigned and should be unique across all patients, family members, and administrators within a particular facility. 2) View (e.g., with sort by column) and Edit or Disable an Enabled Facility. 3) View (e.g., with sort by column) and Edit or Enable a Disabled Facility.

In some embodiments, the Reporting Engine can house reporting logic for both the Reimbursement Report and the CNA Utility Report as well as other reporting. In some embodiments, the Reimbursement Report can be based on parameters selected in the Administration Portal.

In some embodiments, a CNA Utility Report can also be issued. This can be done, for example, by calculating total number of ADL activities performed by the CNA and sort by ADL Type. Data collected can be for the date range specified within the Reporting section of the Administration Web Portal. As another example when Reporting Parameters=By Patient, calculate total number of ADL activities performed on behalf of the patient and sort by ADL Type. Data collected should only be for the date range specified within the Reporting section of the Administration Web Portal.

In some embodiments, the mobile device Application section can capture functionality and logic necessary for CNAs to capture point of service data tied to the ADL activities performed for each patient. The application can also enable bi-directional communication between the CNA and the patient's family as well as communication between the CNA and the DON. In some embodiments, a CNA can pick up one of many iPhones and launch the PatientView application. Once that application has launched, it should ask for the CNA's User Name and Password. The application can be downloadable via the Apple App store, for example, although it should not be functional without a username and password from an authorized user. The first time a CNA logs onto the iPhone application (regardless of which iPhone he uses), the CNA can agree to the Terms and Conditions of the solution. That approval only needs to occur on the first login.

The application can allow a user, for example to 1) Authentication through Login screen prior to any available functionality within the application (inclusive of selectable Facility Name). 2) Develop Login screen inclusive of Username, Password, and Enter button. 3) Upon valid entry of a Username and Password, when the Enter button is selected, the user should be taken to the listing of assigned patients (or filtered patients). If an invalid entry is entered, the user should be brought back to the Login screen and be presented with a notification that the login was invalid (e.g., present “Invalid Entry” text between the Username and Password fields). And/or 4) forget Password functionality can be implemented using the CNA's email address to notify the CNA of the old password.

In some embodiments, patient names can be displayed within two different screens. The default screen can be the listing of patients that have been assigned to the authenticated CNA. This listing can be in alphabetical order based on the last name of the patient. The second screen, for example, can contain a listing of all patients within the facility in alphabetical order based on last name.

Both screens, for example, can have a quick search function (similar to the Contacts application within the native iOS4 system) allowing quick access to any set of patients with the same first letter of the last name. Patients' names within both screens, for example can be selectable and can take the user to the ADL Data Entry screen for the selected patient. In some embodiments, the application can have 1) Develop filtered Patient list screen populated by the Last and First names tied to the Patient IDs that are assigned to the CNA ID of the authenticated user. 2) Develop the non-filtered Patient list screen populated by the Last and First names of all Patient IDs associated with the Facility ID that is assigned to the authenticated user. 3) Indicate which patients have completed all four ADL entries during their session (or shift) (only available on the My Patients Screen . . . not for the all patients view). 4) Indicate which patients have pending family notifications. And/or 5) summarize the total number of pending family notifications. One option would be to indicate the total number of family notifications for all patients on the My Patients tab.

In some embodiments, a CAN section can allow a user to manage certain aspects of their personal data from within the iPhone application. Note: the User ID cannot be altered. For example, a user can 1) Add a new photo via the iPhone camera or any photo stored within the iPhone's photo library. 2) Edit Username. 3) Edit Password.

In some embodiments, an ADL entry section can be used for ADL reimbursements. This application be housed on a mobile device application. In some embodiments, Entry can be accessible for each patient upon the user's selection of a patient's name from either of the patient display screens. Once the patient's name is selected, the following selectable ADL options are presented to the user: Bed Mobility; Transfer; Eating; and/or Toilet Use.

For example, each option can have two selectable paths. First, the user can be able to read a definition of each ADL. Second, the user can be able to select the ADL option and follow user interface. For example, if the user were to select Bed Mobility, s/he would be prompted with the first decision tree question “Are you logging a new ADL?” Prompts would continue until a code is reached and recorded within the PatientView database (tied to the patient ID and time stamped). The final code does not need to be presented to the CAN. Each of the above ADL options, for example, can be completed once per CNA per shift. As such, the application can indicate to the user which ADL codes have been completed/recorded during the CNA's shift (or session), and which ones are still incomplete.

The ADL section can be used, for example, to: 1) Develop the ADL selection screen inclusive of the ADL options listed in 3.3.4. Screen can also include access to ADL definitions (and a path to return to the ADL selection screen) and an entry into the Decision Tree prompts. This screen can also have an indication of which ADLs have a recorded code per CNA per shift. 2) Develop the ADL prompts for each ADL option and record the ADL code within the PatientView database and associate it with the applicable patient ID and provide a timestamp. And/or 3) if a CNA is not logging a new ADL, it is assumed that the CNA is attempting to update the last ADL entered. Any score or code that is generated from that point forward can replace the last score entered.

In some embodiments, the Update Family screen is one of the screens available upon selecting a Patient's name. The purpose of the screen can be to have access to any pending requests from the patient's family. If multiple requests are pending, the CNA should have the ability to select one request and begin the response process. Note: the number of requests that can be received for an individual patient (regardless of which family member sent the request) is controlled from the Facility Management screen within the Administrative Portal. This screen can allow a user, for example, to: 1) Add a picture of the patient via the iPhone's camera or by selecting a photo from the photo library. 2) View any pending requests from the family. 3) Access one of two response methods (Custom or Standard). 4) Access the Courtesy Update screen (if Facility Administrator has selected the ability to use Courtesy Updates within the facility). And/or 5) provide an indication to the CNA of how many pending requests are associated with the selected patient.

A standard update screen can provide a CNA a very quick (and approved) response to a family request. This screen can allow a user, for example, to: 1) Display list of all Standard Responses created through the Administrative Portal within the Manage Communications screen. And/or 2) Allow CNA to select a response and send the response directly to the Family Web Portal 110 inserting any tags that might exist. If family members have selected either the Text or Email options, the Standard Responses should be sent via those communications vehicles as well.

A custom update screen can provide a CNA a very quick (and approved) response to a family request. This screen is provides the CNA the ability to provide a custom response to a family request. Each custom response can be approved by the DON prior to sending to the associated family. This screen can allow a user, for example, to: 1) Enable the CNA to formulate a response via the touch screen keyboard. 2) Enable the CNA to speak an update using Speech to Text technology. 3) Review and/or Edit the output of the Speech to Text content. And/or 4) Submit response to the Manage Communications screen within the Administrative Portal.

A courtesy update screen can allow the CNA with an opportunity to provide an ad-hoc or unsolicited update to the family regarding the patient's health or status. This functionality is only available if selected from within the Manage Facility screen from within the Administrative Portal. This screen can allow a user, for example, to: 1) Enable the CNA to formulate a response via the touch screen keyboard. 2) Enable the CNA to speak an update using Speech to Text technology. 3) Review and/or Edit the output of the Speech to Text content. And/or 4) Submit response to the Manage Communications screen within the Administrative Portal.

In some embodiments, the Family Web Portal can be an access point for authorized family members to access update and status information associated to their patient. Family members will be able to send notification requests directly CNAs as well as determine additional communications vehicles (text and/or email) whereby patient information will be sent. A login screen of the portal can allow a family member, for example, to: 1) Selection of all available facilities within a drop-down selection box. 2) Forget password process available to allow users to receive an email with their assigned password. And/or 3) The first time a user logs into the Family Web Portal, the user can accept the Terms and Conditions of the Family Web Portal. Once those Terms and Conditions are accepted, the user will automatically go to the Managed Patients screen directly following the login activity.

In some embodiments, the message center can be the main page that will be used within the Family Web Portal. It is the default home screen and provides the family member with all necessary communication information related to their patient. This message center can allow a user, for example, to: 1) Present picture of patient (if available) and provide option to update by uploading a new picture. 2) Present a “Welcome” header and present the Admissions date. 3) Present the pictures of all nurses assigned to the patient. 4) Present all automated Daily Performance Updates by taking each ADL score and presenting the meaningful text translation (to be provided later). Additional content for Daily Performance Updates that should be presented are: timestamp, ADL Type, and CNA. The user should be able to sort by any column, with the default being the timestamp. 5) Present all Personalized Updates as submitted by the family member or the CNA. Additional content for Performance Updates that should be presented are: timestamp, ADL Type, and CNA. The user should be able to sort by any column, with the default being the timestamp. 6) Indicate the number of unread Personalized Updates to the user (Note: if another family member under another login has seen an update, it should still appear as an unread note within all other family members. 7) Access Request an Update functionality.

In some embodiments, the Request Update screen is where a family member would request an ad-hoc update to the CNA on behalf of the family member. This screen can allow a user, for example, to 1) Present picture of patient (if available) and provide option to update by uploading a new picture. 2) Present a “Welcome” header and present the Admissions date. 3) Present the pictures of all nurses assigned to the patient. 4) Enable family member to send a written/text status request (limited to 100 characters) and submit to the appropriate CNAs (Note: multiple CNAs will receive the same message if multiple CNAs are assigned to any one patient). This request can be time stamped. 5) Present all past requests in a read-only fashion. If the user is a Family Administrator, s/he may delete or remove completed or pending family requests. 6) Indicate the number of unread Personalized Updates to the user (Note: if another family member under another login has seen an update, it should still appear as an unread note within all other family members.

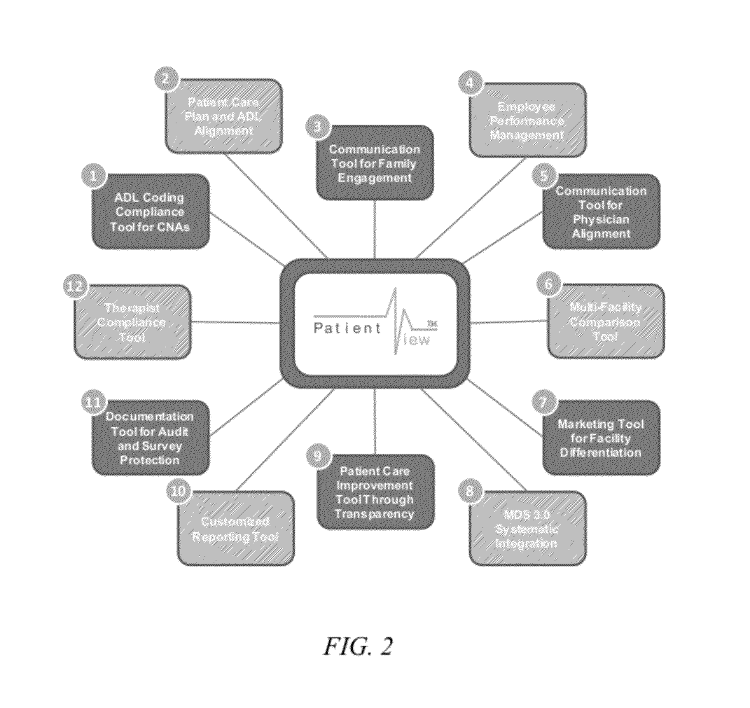

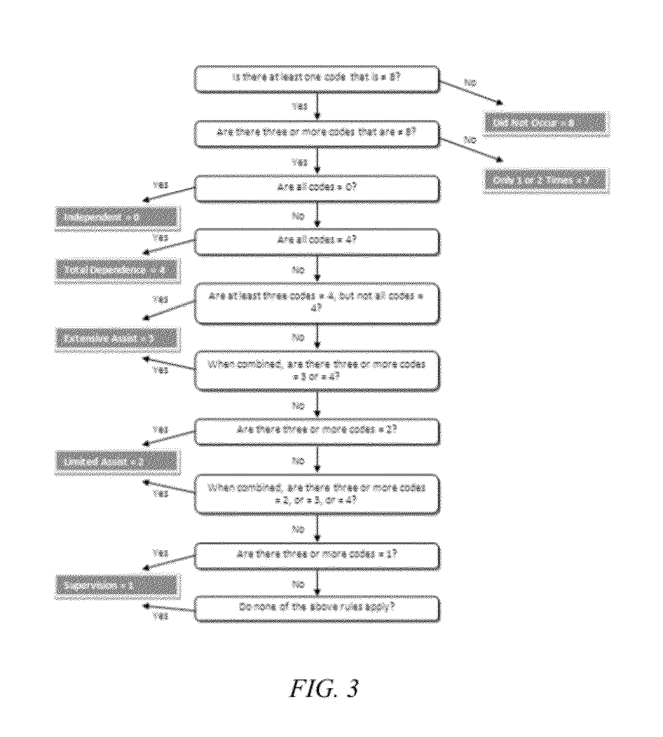

FIG. 2 is a chart showing the various components that can be used to important patient specific data into the PatientView database. FIGS. 3 and 4 both show reporting rules for support provided codes.

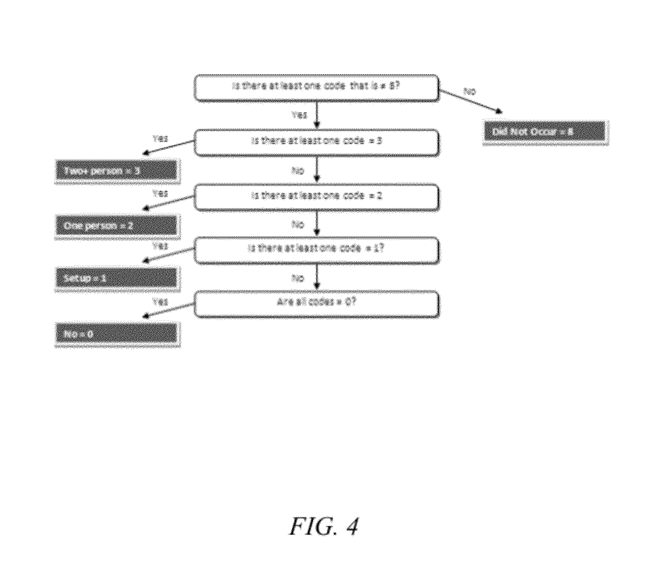

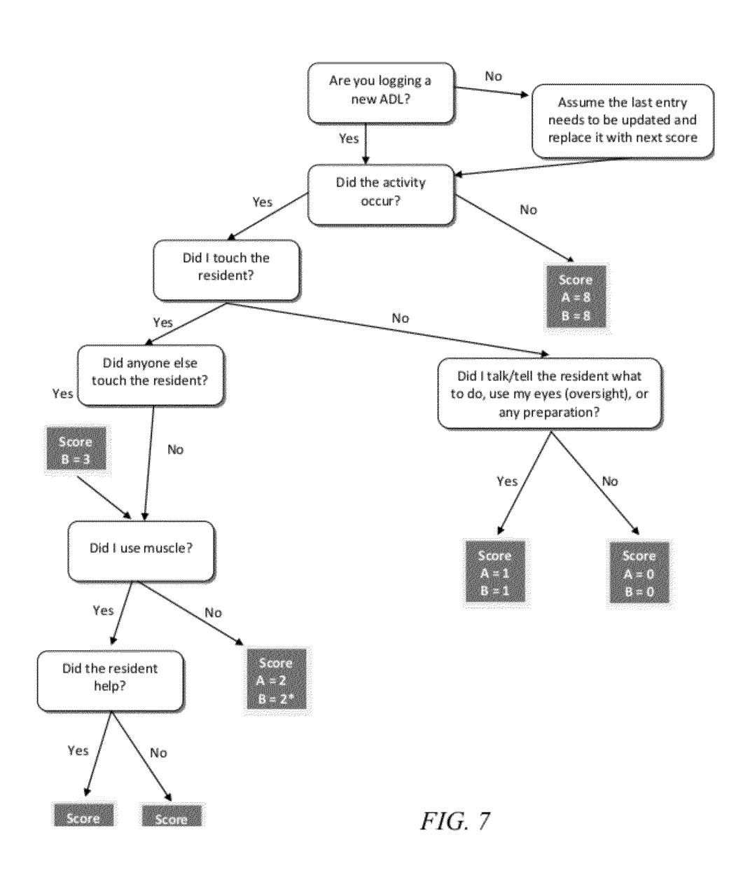

FIG. 5 shows a simplified block diagram of a computer system 500 that can be used in the various embodiments of the invention. Computer system 500 can be used to perform any or all the steps shown in FIG. 4, FIG. 5 and/or FIG. 7. Computer system 500 can also be used with or without all it's components in any of the blocks of FIG. 1 (e.g., database, reporting engine, admin web portal, family web portal, iPhone, etc.). Moreover, computer system 500 can perform any or all the mathematical computations disclosed here. The drawing illustrates how individual system elements can be implemented in a separated or more integrated manner. The computer 500 is shown having hardware elements that are electrically coupled via bus 526. Network interface 552 can communicatively couple the computational device 500 with another computer, for example, through a network such as the Internet. The hardware elements can include a processor 502, an input device 504, an output device 506, a storage device 508, a computer-readable storage media reader 510a, a communications system 514, a processing acceleration unit 516 such as a DSP or special-purpose processor, and memory 518. The computer-readable storage media reader 510a can be further connected to a computer-readable storage medium 510b, the combination comprehensively representing remote, local, fixed, and/or removable storage devices plus storage media for temporarily and/or more permanently containing computer-readable information. Wireless device interface 550 can be used to communicate with any wireless device in conjunction with network interface 552.

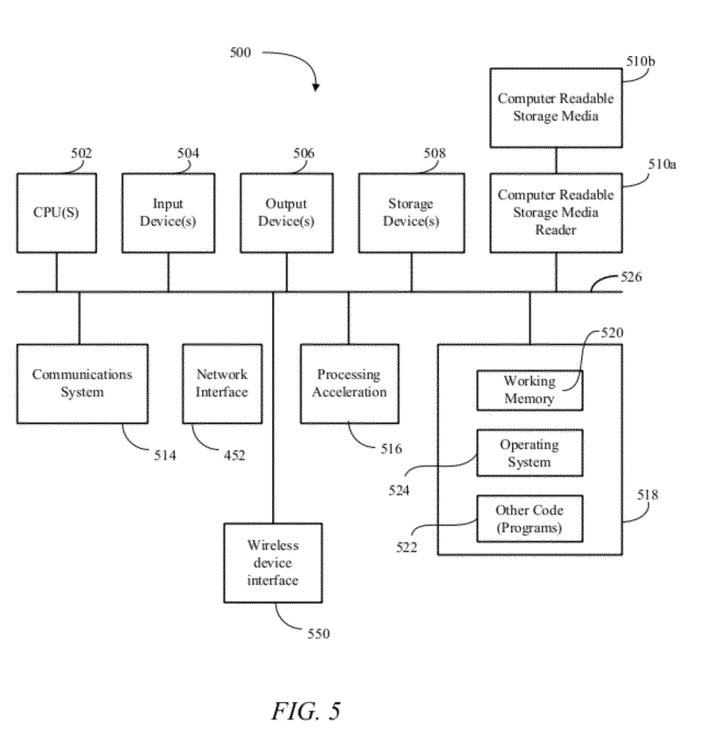

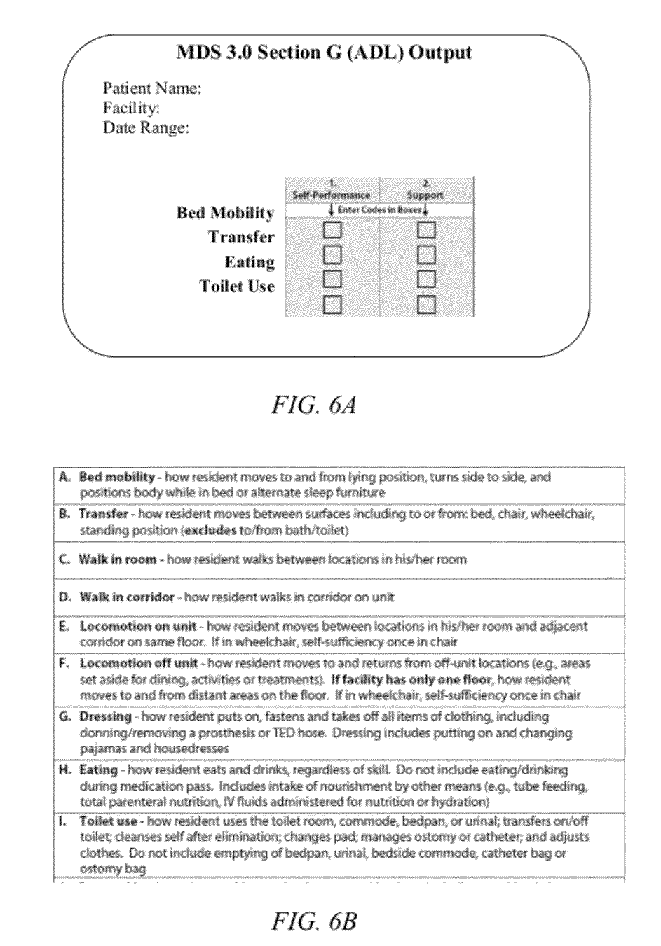

FIG. 6A shows a sample ADL report with a patient's bed mobility scores. And FIG. 6B is a sample chart of various ADL codes. FIG. 7 is a flow chart showing a standard iPhone application user interface and coding according to some embodiments of the invention.

What is claimed is:

1. A method comprising:
receiving information related to daily living of a patient from a mobile device used by a caregiver;
entering the information into a database; and
creating a report from the information entered into the database; and
delivering the report to a third party.

2. The method according to claim 1, wherein the report is delivered via email or text message.

3. The method according to claim 1, wherein the report is delivered to a third party distinct from the patient or the caregiver.

4. The method according to claim 1, wherein the report includes billable codes related to the information related to daily living.

5. A system for collecting information about activities of daily living comprising:
a first communication interface;
a second communication interface;
a database;
a processor coupled with the first communication interface, the second communication interface, and the database, wherein the processor is configured to
receive patient data through the first communication interface from a medical worker;
correlate the patient data into a report; and
sending the report to a third party through the second communication interface.

6. The system for collecting information about activities of daily living according to claim 5, wherein either or both the first communication interface comprises a web portal.

7. The system for collecting information about activities of daily living according to claim 5, wherein the report includes billing codes.

8. The system for collecting information about activities of daily living according to claim 5, wherein the report is sent to the third party in response to a triggering event.
